(19) United States
(12) Patent Application Publication
(10) Pub. No.: US 2026/0267853 A1
(43) Pub. Date: Sep. 10, 2026

(54) DATABASE QUERY TRANSLATION AND SCHEMA SYNTHESIS TECHNIQUES

(71) Applicant: Adobe Inc., San Jose, CA (US)

(72) Inventors: Kun Qian, Sammamish, WA (US); Yunyao Li, San Jose, CA (US); Tianshu Zhang, Columbus, OH (US); Siddhartha Sahai, Bellevue, WA (US); Shaddy Garg, Distt. Moga (IN)

(73) Assignee: Adobe Inc., San Jose, CA (US)

(21) Appl. No.: 19/069,754

(22) Filed: Mar. 4, 2025

(51) Int. Cl. G06F 16/2452; G06F 16/21; G06F 16/242

(52) U.S. Cl. CPC G06F 16/24522; G06F 16/213; G06F 16/243

(57) ABSTRACT

Database query translation and schema synthesis techniques are described. These techniques support training data generation usable to train a machine-learning model to translate a natural language query into a database query. A database system is configurable to address a variety of evolution types to a database schema in support of machine-learning model training through use of a training data generation module. The training data generation module is configurable to generate database query variations that address different types of database schema evolutions. An evaluation module is also configurable as part of the database system to evaluate operability of a trained machine-learning model to perform query translation using an evaluation module.

### BACKGROUND

Natural language interfaces have been employed by database systems to broaden user access to a database. Access to conventional database systems, for instance, initially involved specialized knowledge regarding what database queries are supported, an overall database schema employed to store records, and so forth. As such, these initial conventional techniques were limited to sophisticated users having significant amounts of experience that is typically gained over a long period of time.

Consequently, additional conventional techniques were developed in an attempt to broaden this user access by supporting natural language functionalities. However, these additional conventional techniques encounter numerous technical challenges that hinder the accuracy and performance of the database access. These technical challenges include an inability of conventional techniques to adapt to diverse database schemas and domain-specific terminology that in real-world scenarios typically evolves over time. Further, conventional techniques struggle to evaluate an effect of the adaptations of these natural language functionalities in addressing these schema changes.

### SUMMARY

Database query translation and schema synthesis techniques are described. These techniques support training data generation usable to train a machine-learning model to translate a natural language query into a database query, e.g., a structured query language (SQL) query. A database system, for instance, is configurable to address a variety of evolution types to a database schema in support of machine-learning model training through use of a training data generation module. The training data generation module is configurable to generate database query variations that address different types of database schema evolutions. An evaluation module is also configurable as part of the database system to evaluate operability of a trained machine-learning model to perform query translation using an evaluation module, which is not possible in conventional techniques.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ database query translation and training data generation techniques described herein.

FIG. 2 depicts a system in an example implementation showing operation of a schema synthesis system FIG. 1 in greater detail as generating training data and evaluating operation of a machine-learning model trained using the training data to translate a natural language query to a database query.

FIG. 3 depicts an example system showing operation of a column variation module and a table variation module of a training data variation module of FIG. 2 in greater detail.

FIG. 4 depicts an example implementation of column-level and table-level variations as generated by a training data variation module of FIG. 3.

FIG. 5 depicts a system in an example implementation showing operation of an evaluation module of FIG. 1 in greater detail as tasked with processing database query variations as part of training data generation.

FIG. 6 depicts a system showing operation of the database system in greater detail as training a machine-learning model of FIG. 1 based on training data of FIG. 2.

FIG. 7 is a flow diagram depicting an algorithm as a step-by-step procedure in an example implementation of operations performable for accomplishing a result of training data generation and training a machine-learning model for natural language to database query translation.

FIG. 8 is a flow diagram depicting an algorithm as a step-by-step procedure in an example implementation of operations performable for accomplishing a result of training data generation and training a machine-learning model for natural language to database query translation.

FIG. 9 depicts a system in an example implementation showing training of the machine-learning model of FIG. 1 in greater detail using the training data as generated in FIG. 2.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

### Overview

Complexity of databases and database schemas used to control how records are stored and accessed from the databases continues to increase in response to a variety of factors including increases in the types of data stored, amounts of data stored, functionalities supported by the databases, and so forth. Consequently, conventional database access is often limited to sophisticated users having significant amounts of experience that is typically gained over a significant amount of time in order to gain specialized knowledge.

Conventional techniques have been subsequently developed to implement natural language interfaces in order to expand database access to “nontechnical” individuals. These techniques typically involve translating natural language questions into database queries compatible with formal database query languages that are understood by a database system. However, conventional techniques often fail in this translation due to a variety of technical challenges, including an inability to adapt to diverse database schemas and domain-specific terminology across different contexts. Because of this, translation performance of these conventional techniques often deteriorates substantially in real-world scenarios when applied to new domains or updated database structures. Furthermore, conventional techniques are unable to accurately evaluate an effect of adaptations changes made in order to address evolution of the database schema.

Accordingly, a database query translation and schema synthesis techniques are described. These techniques support training data generation usable to train a machine-learning model to translate a natural language query into a database query, e.g., a structured query language (SQL) query. A database system, for instance, is configurable to address a variety of evolution types to a database schema in support of machine-learning model training through use of a training data generation module. The database system is also configurable to evaluate operability of the trained model to perform query translation using an evaluation module. In this way, access to the database system is expanded to users having generalized knowledge by a machine-learning model that is trained and evaluated using the techniques described herein.

In a first example, a training data generation module receives a plurality of natural language queries and a corresponding plurality of database queries based on a database schema. The plurality of database queries are provided as examples of translation of the plurality of natural language queries for processing by a database. The training data generation module is then employed to generate training data that is configurable to address changes to the database schema.

To do so, the training data generation module is configured to generate a plurality of database query variations, e.g., as “perturbations” of the database queries. The database query variations, for instance, are formed as perturbations of the database queries as a way to simulate different types of schema variations in a configurable manner. The training data generation module is operable to generate the database query variations directly as changes to the database queries, indirectly from an edited database schema formed from a database schema is originally used to generate the database queries, and so forth.

The training data generation module, for instance, is configurable to implement a variety of column variations, examples of which include an add column variation, a remove column variation, and a rename column variation. The training data generation module is also configurable to implement a variety of table variations, examples of which include an add table variation, a remove table variation, a rename table variation, a split table variation, and a merge table variation. A variety of other examples are also contemplated.

In this way, the training data generation module encapsulates a broad range of schema evolution types, thereby addressing prevalence and impact of these evolutions in real-world scenarios. The training data generation module, for instance, is configurable to employ a schema evolution taxonomy as described above including both column-level and table-level variations. For a column-level scenario, the training data generation module may add a new “discount” column to a sales table, which could affect how the database queries calculate total sales.

In contrast, table-level variations may involve managing relationships among different tables and can substantially alter data distributions. For example, a table-level scenario may involve merging two tables, such as by combining a “customer” table with an “order details” table into a single “customer_orders” table to streamline database structure and queries. These variations generated by the training data generation module, automatically and without user intervention (e.g., are “automated”), are common in real-world scenarios and thus support robust handling and operation in real-world scenarios to database schema changes.

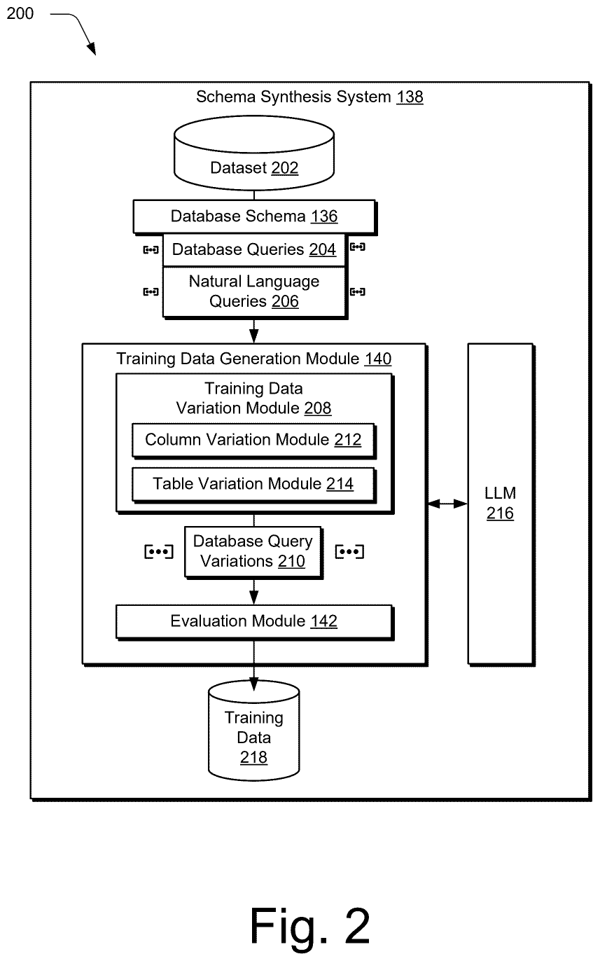

Training data is then generated as including the plurality of database query variations as corresponding to the plurality of natural language queries and may also include the database schema, the edited database schema, and so forth. After which, a machine-learning model is trained using this training data by the database system to perform query translation of a natural language query into a database query usable to search a database. Further discussion of training data generation may be found in relation to FIGS. 2-4 and 7.

In one or more additional examples, conventional evaluation techniques for assessing accuracy of natural language to database query translations face several technical challenges. These technical challenges include difficulties in handling schema variations, difficulties in accounting for semantic equivalence of queries, and challenges in simulating real-world schema evolution scenarios similar to the difficulties in machine-learning model training as described above. Conventional techniques, for instance, often rely on exact string matching or simplified metrics that fail to capture differences in query structure and semantics. Additionally, conventional techniques struggle to evaluate robustness against schema changes, which is central in support of real-world applications where database structures frequently evolve.

To address these and other technical challenges, the evaluation module employs a comprehensive approach to assess translation accuracy and model robustness. The evaluation module, for instance, is configurable to employ a variety of metrics, examples of which include a table match score, a column match score, and so forth. The table match score is a measure of how accurately the machine-learning model identifies a “correct” table for a given query. The column match is a measure of precision in selecting appropriate columns. These metrics support a detailed evaluation of machine-learning model operation in translation of a natural language query beyond simple string matching. Furthermore, the evaluation module is configurable to systematically apply various schema variations to test scenarios, allowing for a thorough assessment of machine-learning model performance under different schema evolution conditions.

For example, consider a real-world scenario where a customer database undergoes restructuring. An original database schema might have a single “customers” table containing an entirety of the customer information. The evaluation module may then simulate a schema evolution where this table is split into separate “personal_info” and “purchase_history” tables. The evaluation module then assess “how well” a natural language to database translation adapts to this change by comparing the generated queries against the original database queries (i.e., database queries as received for a database schema that is not modified) for both the original and edited database schemas.

The evaluation module may also evaluate a query of “Find each of the customers who made purchases in the last month,” ensuring that the machine-learning model correctly joins the new tables and adjusts column references accordingly. This approach to evaluation provides insights into an ability of the trained machine-learning model to handle complex schema changes while maintaining query accuracy, offering increased realism and supporting comprehensive evaluation of query translation techniques implemented using the machine-learning model. Further discussion of implementation of the evaluation module may be found in relation to FIGS. 2, 5, 6, and 8.

### Term Examples

A “database schema” defines tables as fundamental units of data storage, each table having of rows and columns. Each row represents a unique record, while each column represents a specific attribute of the data. The database schema is definable in a variety of ways, examples of which include use of a data definition language (DDL), such as a structured query language (SQL), which provides commands for creating, altering, and deleting schema objects.

“Columns” are defined within the tables and specify a type of data that can be stored (e.g., integer, varchar, date) and respective constraints, e.g., primary key, foreign key, not null, and so forth.

“Data types” define the nature of the data that are storable in each column, such as integers, strings, dates, and binary data.

“Indexes” are structures that support retrieval operations on a database table.

“Constraints” include rules enforced on data columns to ensure data integrity and consistency. Examples of constraints include primary keys, foreign keys, unique constraints, and check constraints.

“Relationships” define logical connections between tables, typically defined through foreign keys, which establish referential integrity between related data.

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Database Query Translation Environment

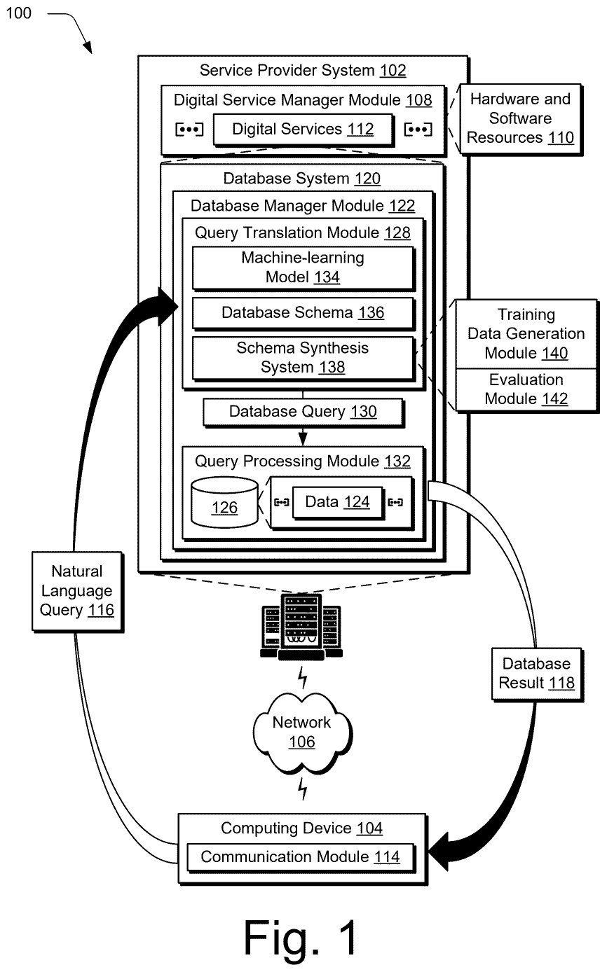

FIG. 1 is an illustration of a digital medium environment 100 in an example implementation that is operable to employ database query translation and schema synthesis techniques described herein. The illustrated environment 100 includes a service provider system 102 and a computing device 104 that are communicatively coupled, one to another, via a network 106. Computing devices are configurable in a variety of ways.

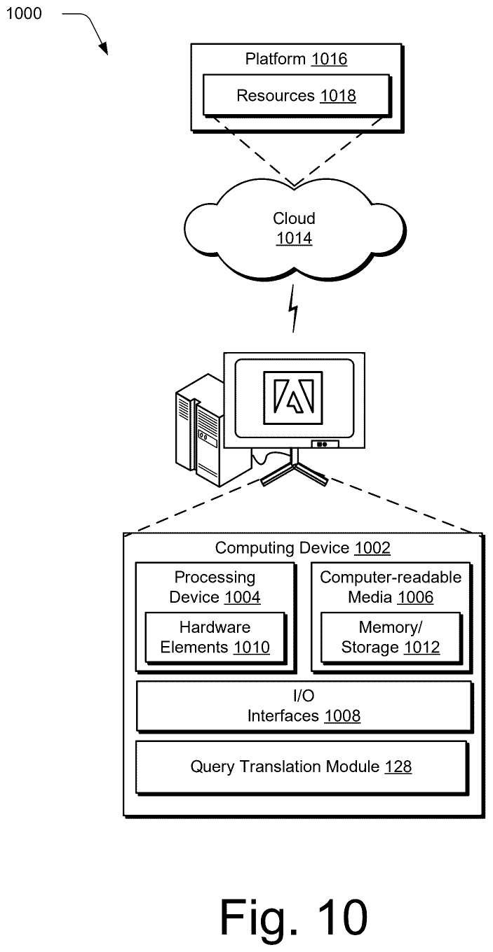

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 10.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the communication module 114 outputs a natural language query 116 that is processed to generate a database result 118 by a database system 120 implemented by the digital services 112. Other examples are also contemplated in which the database system 120 is implemented locally at the computing device 104. The database system 120 includes a database manager module 122 that is configured to manage access to data 124 (e.g., records) maintained in a database 126.

To do so, the database manager module 122 is configured to expand accessibility to the data 124 as part of the database 126 through use of a query translation module 128 without involving specialized knowledge as was involved using conventional techniques. The query translation module 128 is configured to translate the natural language query 116 into a database query 130 (e.g., in compliance with a data definition language (DDL)) using a machine-learning model 134. The database query 130 is then processed using a query processing module 132 to generate a database result 118 from the data 124 in the database 126. The machine-learning model 134 is trained in this example using training data based on a database schema 136 which may include domain specific knowledge.

A database schema 136 defines a logical configuration of a relational database, including tables, columns, data types, indexes, and the relationships between these entities. The database schema 136 serves as a blueprint for constructing and managing the database, ensuring data integrity, consistency, and accessibility. A database schema 136, for instance, defines tables as fundamental units of data storage, each table having of rows and columns. Each row represents a unique record, while each column represents a specific attribute of the data. Columns are defined within the tables and specify a type of data that can be stored (e.g., integer, varchar, date) and respective constraints, e.g., primary key, foreign key, not null, and so forth.

Data types define the nature of the data that are storable in each column, such as integers, strings, dates, and binary data. Indexes are structures that support retrieval operations on a database table. Constraints include rules enforced on data columns to ensure data integrity and consistency. Examples of constraints include primary keys, foreign keys, unique constraints, and check constraints. Relationships define logical connections between tables, typically defined through foreign keys, which establish referential integrity between related data. The database schema 136 is definable in a variety of ways, examples of which include use of a data definition language (DDL), such as a structured query language (SQL), which provides commands for creating, altering, and deleting schema objects.

Database schemas 136 as previously described frequently evolve to support additional functionalities and usage scenarios. This evolution introduces technical challenges to database systems that support translation of natural language queries to database queries, e.g., structured query language (SQL) database queries. Evolution of a database schema 136, for instance, may vary widely from minor modifications to a complete restructuring. As a result, operation of machine-learning models that are trained on a static database schema in support of database query translation is often hindered, results in inaccuracies, and causes inefficient use of computational resources.

In conventional techniques, for instance, training data used to train a machine-learning model for query translation is manually created. In real world scenarios, however, the machine learning models are tasked with adapting to continual changes in database schemas, which introduces several technical challenges. As such, this manual approach is time-consuming, labor-intensive, and computationally resource intensive due to tasking domain experts to generate diverse and representative examples in response to each schema update. Further, this manual approach struggles to keep pace with frequent database schema changes, leading to a constant lag between database schema updates and corresponding machine-learning model adaptations and training. The manual approach is also prone to human biases and inconsistencies, potentially resulting in datasets that do not adequately cover a full range of possible queries or fail to capture subtle schema nuances.

Furthermore, as complexity of schemas increases, the difficulty of manually crafting accurate and diverse query-result pairs also increases. This complexity makes it technically challenging to maintain dataset quality and comprehensiveness of training data that is used to train the machine-learning models. Because of this, machine-learning models may be trained that perform well on common query patterns but fail on edge cases or newly introduced schema elements of an updated database schema with little to no insight into whether the failures are even encountered. The scalability of manual data creation is also limited, making it impractical for large-scale, rapidly evolving database systems to employ continuous adjustments in order to maintain performance and accuracy.

Accordingly, to address these and other technical challenges the query translation module 128 employs a schema synthesis system 138. The schema synthesis system 138 includes a training data generation module 140 that is configured to improve generation and accuracy of training data usable to train the machine-learning model 134 to perform query translation. The training data generation module 140, for instance, is configurable to generate training data that includes a plurality of database query variations and a corresponding plurality of natural language queries.

The plurality of database query variations, for instance, are configurable to include column-level variations, table-level variations, and so forth as found in real-world scenarios. The database query variations may be generated in a variety of ways, such as through direct edits to database queries, to a database schema that is used to generate the database queries, and so forth. The database query variations are then usable along with corresponding natural language queries as training data to train a machine-learning model to translate a natural language query into a database query. Further discussion of training data generation may be found in relation to FIGS. 2-4 and 6.

The schema synthesis system 138 also employs an evaluation module 142 that is configurable to evaluate operation of the machine-learning model 134, e.g., accuracy of training to address evaluation of the database schema 136. The evaluation module 142, for instance, is configurable to employ a variety of metrics, such as a table match score, a column match score, and so forth. The table match score is a measure of how accurately the machine-learning model 134 identifies a “correct” table for a given query. The column match is a measure of precision in selecting appropriate columns.

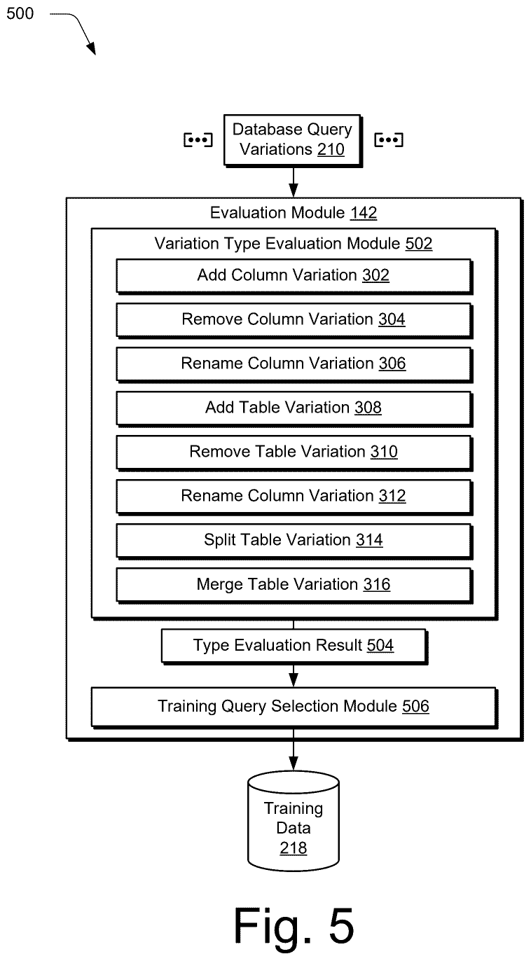

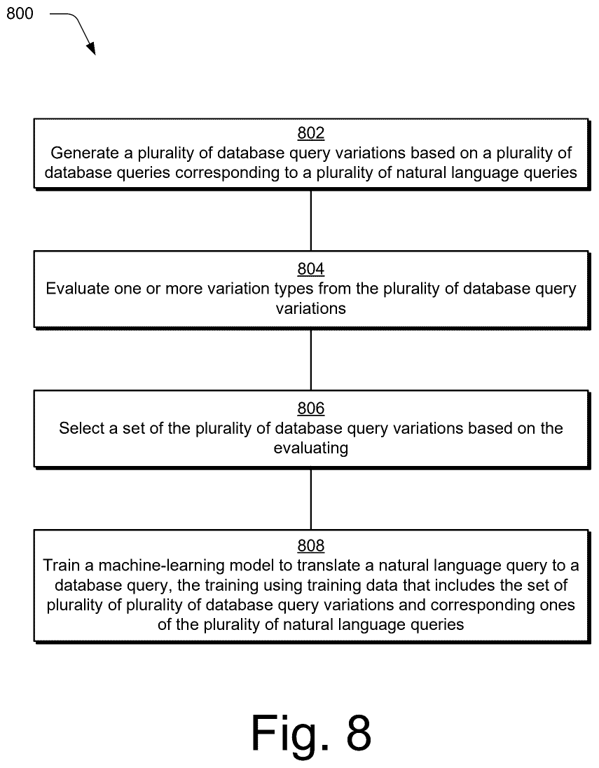

These metrics support a detailed evaluation of machine-learning model 134 operation in translation of a natural language query beyond simple string matching. Furthermore, the evaluation module 142 is configurable to systematically apply various schema variations to test scenarios, allowing for a thorough assessment of machine-learning model performance under different schema evolution conditions, further discussion of which may be found in relation to FIGS. 5 and 8.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Training Data Generation and Evaluation Techniques

The following discussion describes training data generation and evaluation techniques usable for training a machine-learning model to translate a natural language query into a database query that are implementable utilizing the described systems and devices. The following discussion further describes evaluation techniques usable to evaluate operation of the trained machine-learning model. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 2 depicts a system 200 in an example implementation showing operation of the schema synthesis system 138 of FIG. 1 in greater detail as generating training data and evaluating operation of a machine-learning model trained using the training data to translate a natural language query to a database query. To begin in this example, the training data generation module 140 accesses a dataset 202 to receive a database schema 136, a plurality of database queries 204, and a corresponding plurality of natural language queries 206.

The dataset 202 is configurable as a collection of high-quality (e.g., expert-curated) examples that serve as the ground truth for natural language to database query translation tasks. The natural language queries 206 are configurable as questions or commands expressed in everyday language that a user may ask about the data 124 in a database 126. The database queries 204 correspond, respectively, to the natural language queries 206 that accurately answer or fulfill the natural language queries 206. The database queries 204, for instance, may be considered a “gold standard” or “ideal translations” of the natural language queries 206. The database schema 136 is included as detailing a context and structure of the data 124 being queried in the database 126 as previously described.

The dataset 202 serves as a foundation for generating training data usable to train the database schema 136 as a mapping between natural language queries and database queries. The dataset 202 is also configurable as an evaluation benchmark to act as a reference point for assessing the performance of query translations systems. The dataset 202 also serves as a starting point from which various schema perturbations are generated, allowing for the creation of training data that reflects diverse and challenging evaluation scenarios. In this way, the dataset 202 acts as a foundation for generating schema perturbations and evaluating machine-learning model robustness to schema evolution as further described below.

The training data variation module 208 is configurable to generate a plurality of database query variations 210 based on the dataset 202 in a variety of ways. In a first example, the training data variation module 208 generates a plurality of database query variations 210 directly from the database queries 204. The training data variation module 208, for instance, may apply a variety of transformation techniques to the database queries 204. These transformations may include reordering clauses, adding or removing redundant expressions, changing the syntax while preserving semantics, introducing alternative ways to express the query logic, and so forth. For example, a “SELECT” statement might be rewritten using different join types, subqueries might be transformed into joins or vice versa, or aggregate functions could be expressed using alternative methods.

In a second example, the training data variation module 208 generates a plurality of database query variations 210 indirectly based on edits to the database schema 136. When the database schema 136 is modified, such as by adding, removing, or renaming columns or tables, or by splitting or merging tables, the training data variation module 208 automatically adjusts the original queries to accommodate these changes. For instance, if a table is split, the training data variation module 208 introduces a “JOIN” clause to reconnect the now separate data. If a column is renamed, each of the references to that column in the queries are updated accordingly. In scenarios involving complex schema changes, such as table merges, the training data variation module 208 restructures the queries, thereby combining multiple queries or modifying the logic to achieve a same result with the new schema structure. This indirect variation process ensures that the generated queries remain valid and semantically equivalent to original intentions of the database schema 136, despite subsequent evolutions.

In one or more implementations, the training data variation module 208 is configurable to apply a variety of perturbations to each seed instance of the database queries 204 while keeping corresponding natural language queries 206 fixed. To do so, the training data variation module 208 includes a column variation module 212 that is configurable to implement column-level changes, e.g., adding, removing, and renaming columns.

The training data variation module 208 is also configurable to include a table variation module 214 to implement table-level changes, e.g., adding, removing, renaming, splitting, and merging tables. The training data variation module 208, for instance, is configurable to employs heuristics, a large language model (e.g., LLM 216) and so forth, e.g., to generate names for new columns or tables, determine how to logically split or merge table, and so forth. The training data generation module 140, for instance, is configurable to generate a prompt that includes a database query 204 and details a respective variation to be applied to the database query 204.

In one or more additional implementations, the training data generation module 140 is configured to edit the database schema 136 to form an edited database schema. The edited database schema is then used to adjust the corresponding database queries 204 and thereby form the plurality of database query variations 210 to maintain consistency with the schema changes. This adjustment process ranges from straightforward replacements for simple perturbations like column renaming to complex revisions for table splitting or merging.

Throughout this process, the training data generation module 140 applies heuristics to ensure data quality and consistency, such as maintaining foreign key relationships and avoiding duplicate column names. The result is formation of training data 218 having multiple variations of each original seed instance, each featuring a different schema perturbation but retaining correspondence to the same natural language queries 206. This technique creates a rich, diverse training dataset 218 that that is usable to train the machine-learning model 134 to distinguish between different schema designs and adapt translation accordingly. By synthetically generating the training data 218 automatically and without user intervention (i.e., is “automated”) to cover a wide range of potential schema evolution scenarios, schema synthesis system 138 reduces and even eliminates manual annotation of changes to the database schema 136 with increased efficiency and responsiveness to schema changes.

The evaluation module 142 may also be employed by the training data generation module 140 as part of generating the training data 218. The evaluation module 142, for instance, is usable to analyze performance of the machine-learning model 134 across a variety of types of schema perturbations. Analysis of the performance is a way to provide insights into types of schema changes that are accurately addressed, pose technical challenges, and so forth. These insights are then leveraged by the evaluation module 142 to create targeted and effective training data 218, e.g., by filtering the database query variations 210 into a set for inclusion in the training data 218.

The evaluation module 142, for instance, may identify that accuracy of the machine-learning model 134 struggles with respective to table splitting operations. The training data generation module 140 may therefore prioritize creation of examples of this perturbation type as part of the training data 218. To do so, the evaluation module 142 may employ a variety of metrics, such as a table match metric, a column match metric, and so forth as further described in relation to FIG. 5.

In this way, the evaluation module 142 may guide generation of training data 218 by the training data variation module 208 by highlighting specific areas for improvement. This feedback ensures that the training data 218 is comprehensive and also focused on addressing real-world schema evolution challenges. Additionally, assessment of query correctness under various schema modifications by the evaluation module 142 supports validation and refinement of the training data 218, ensuring that the training data 218 accurately reflects complexities of schema evolution scenarios encountered in real-world scenarios.

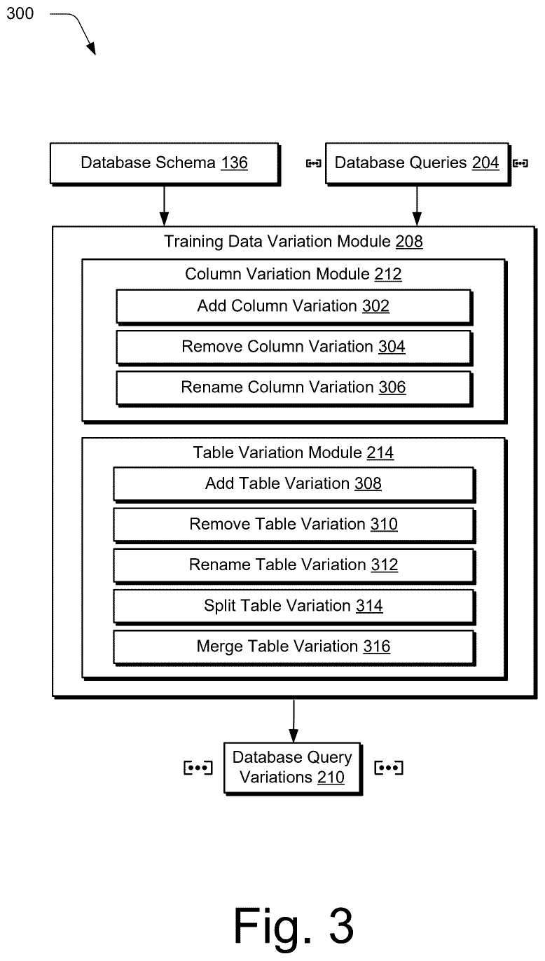

FIG. 3 depicts an example system 300 showing operation of the column variation module 212 and the table variation module 214 of the training data variation module 208 of FIG. 2 in greater detail. The column variation module 212 is usable to generate a variety of variations as perturbations based on the database schema 136 and/or the database queries 204. Examples of these column-level variations include an add column variation 302, remove column variation 304, a rename column variation 306, and so forth.

The column variation module 212, for instance, may generate an add column variation 302 based on the database schema 136 and/or the database queries 204. Consider a scenario in which a company's database schema 136 initially includes a “products” table with columns for “product_id,” “name,” and “price.” The column variation module 212 then generates an add column variation 302 by introducing a new “discount_percentage” column to the “products” table. This addition, for instance, may be based on analyzing frequent database queries 204 that calculate discounted prices, such as “SELECT name, price (1-0.1) AS discounted_price FROM products WHERE category=‘electronics.=” By adding the “discount_percentage” column, the column variation module 212 edits the database schema 136 to directly store discount information. The column variation module 212 then adjusts relevant database queries 204 to utilize this new column, transforming the previous query into ”SELECT name, price (1−discount_percentage) AS discounted_price FROM products WHERE category=‘electronics.’”

In another instance, the column variation module 212 generates a column variation 304 based on the database schema 136 and/or the database queries 204. Consider a scenario involving a healthcare database schema 136 that includes a “patients” table with columns such as “patient_id,” “name,” “date_of_birth,” “blood_type,” and “allergies.” Upon analyzing the database queries 204, the column variation module 212 detects that the “blood_type” column is rarely used in queries, e.g., is outdated or redundant. As a result, the column variation module 212 generates a remove column variation 304 by eliminating the “blood_type” column from the “patients” table. This modification is further supported by examining frequent database queries 204 like “SELECT patient_id, name, allergies FROM patients WHERE date_of_birth>‘1990-01-01,’” which do not reference the “blood_type” column. The column variation module 212 then adjusts database queries 204 that use the removed column, such as transforming “SELECT name, blood_type FROM patients WHERE allergies LIKE ‘%penicillin%’” into “SELECT name FROM patients WHERE allergies LIKE ‘%penicillin%.’”

In a further instance, the column variation module 212 generates a rename column variation 306 based on the database schema 136 and/or the database queries 204. Consider a scenario involving a human resources database schema 136 that includes an “employees” table with columns such as “emp_id,” “first_name,” “last_name,” and “annual_salary.” Upon analyzing the database queries 204, the column variation module 212 detects use a full name of employees and monthly salaries. As a result, column variation module 212 generates a rename column variation by changing “first_name” to “given_name,” “last_name” to “family_name,” and “annual_salary” to “monthly_compensation.” This modification is supported by examining frequent database queries 204 like “SELECT first_name ||‘‘|| last_name AS full_name, annual_salary/12 AS monthly_pay FROM employees WHERE department=‘Sales.’” The column variation module 212 then adjusts the database queries 204 to use the new column names, transforming the previous query into “SELECT given_name ||‘‘|| family_name AS full_name, monthly_compensation FROM employees WHERE department=‘Sales.’” A variety of other column-level variations are also contemplated.

The table variation module 214 is also configurable to implement a variety of table-level modifications to simulate different types of schema evolution scenarios. These modifications may include an add table variation 308, a remove table variation 310, a rename table variation 312, a split table variation 314, and a merge table variation 316. The table variation module 214 may apply these variations individually or in combination to generate diverse schema perturbations usable to generate training data.

For the add table variation 308, the table variation module 214 introduces new tables into the existing database schema, e.g., to expand the scope of the training data. In a real-world scenario, a database may add a new “customer_reviews” table to capture customer feedback separately from the main “orders” table. When removing tables to implement the remove table variation 310, the table variation module 214 eliminate tables from the database schema, simulating scenarios where certain data entities are no longer relevant or have been consolidated elsewhere. For instance, a social media platform might remove a standalone “user_interests” table after integrating this information into a comprehensive “user_profile” table.

The rename table variation 312 is usable by the table variation module 214 to alter table names while preserving a corresponding structure and relationships, which can occur when standardizing naming conventions or rebranding. For instance, a company might rename its “employees” table to “team_members” to reflect a cultural shift in how it refers to its workforce.

The split table variation 314 is usable by the table variation module 214 to divide a single table into multiple tables, e.g., to normalize data, improve query performance, and so forth. For example, a large “products” table in a retail database is split into separate “product_details” and “product_inventory” tables to optimize data access patterns. Conversely, the merge table variation 316 may be used by the table variation module 214 to combine multiple tables into a single table, e.g., for denormalization or simplifying schema complexity. In a healthcare system, for instance, separate “patient_demographics” and “patient_medical_history” tables are merged into a unified “patient_records” table to provide a holistic view of patient data. Again, a variety of other table-level variations are also contemplated.

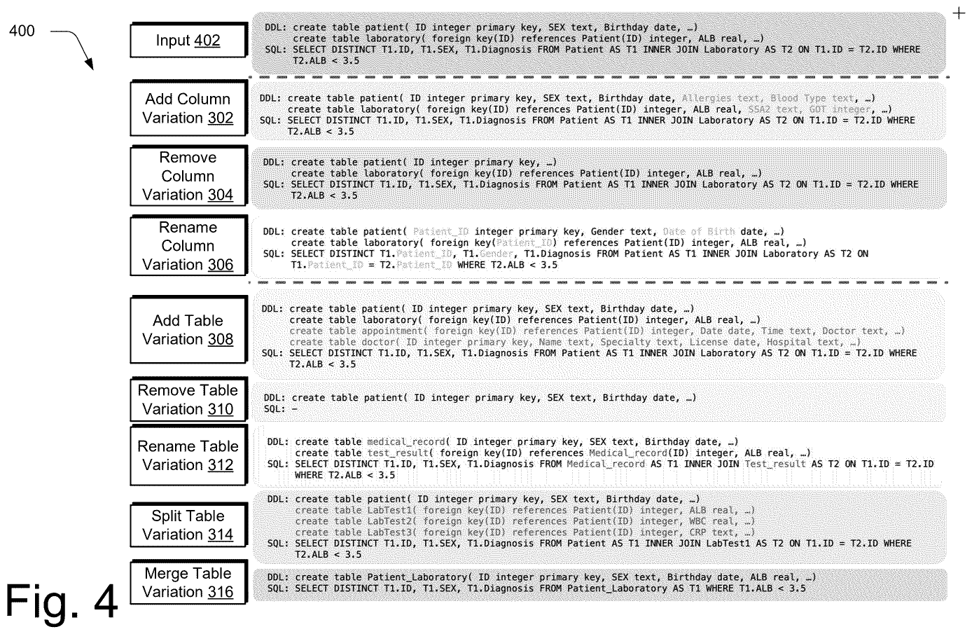

FIG. 4 depicts an example implementation 400 of examples of column-level and table-level variations as generated by the training data variation module 208 of FIG. 3. This implementation 400 includes variation examples of an input 402 database query including an add column variation 302, a remove column variation 304, a rename column variation 306, an add table variation 308, a remove table variation 310, a rename table variation 312, a split table variation 314, and a merge table variation 316 as previously described in relation to FIG. 3.

The illustrated input 402 includes a “Patient” table containing columns for “Id,” “Sex,” “Date,” and “Diagnosis.” The add column variation 302 is demonstrated by adding a “Birthday” column to the “Patient” table. This may occur when additional patient information is to be tracked, such as for age-based analysis or birthday notifications.

The remove column variation 304 is illustrated by removing the “Sex” column from the “Patient” table. This variation be implemented in scenarios where gender information is no longer collected or relevant for the specific medical context. The rename column variation 306 is shown by changing the “Date” column to “VisitDate.” This variation may be generated to improve clarity and specificity of the column's purpose within the patient records in real-world scenarios.

Table-level variations are also shown. The add table variation 308 is demonstrated by introducing a new “Laboratory” table to the existing schema. This table may contain columns such as “TestId,” “PatientId,” “TestName,” and “Result,” allowing for storage of detailed laboratory test information separate from the main patient data.

The remove table variation 310 is shown by eliminating an existing “Medication” table from the schema. This table may have contained information about prescribed medications, including columns like “MedicationId,” “PatientId,” “DrugName,” and “Dosage.” The rename table variation 312 is depicted by changing a name of the “Appointment” table to “Consultation.” This table may include columns such as “ConsultationId,” “PatientId,” “DoctorId,” “DateTime,” and “Purpose.” The rename table variation 312, like the rename column variation 306, may reflect a shift in terminology, e.g., to emphasize an interactive nature of patient visits rather than a scheduling aspect, solely.

The split table variation 314 is depicted by dividing the original “Patient” table into two separate tables: “Patient_Info” (containing “Id,” “Sex,” “Birthday”) and “Patient_Diagnosis” (containing “Id,” “Date,” “Diagnosis”). The merge table variation 316 is illustrated as the reverse process, combining the “Patient_Info” and “Patient_Diagnosis” tables back into a single “Patient” table. A variety of other examples of perturbations as part of generating database query variations for training data are also contemplated.

FIG. 5 depicts a system 500 in an example implementation showing operation of the evaluation module 142 of FIG. 1 in greater detail. In this example, the evaluation module 142 is tasked with processing database query variations 210 as part of forming the training data 218. Other evaluation scenarios are also contemplated.

The evaluation module 142 includes a variation type evaluation module 502 that is configured to evaluate effect of different types of variations (e.g., perturbations) on operation of a trained machine-learning model. Examples of the types of variations includes an add column variation 302, a remove column variation 304, a rename column variation 306, an add table variation 308, a remove table variation 310, a rename table variation 312, a split table variation 314, and so on.

The evaluation module 142 is configurable to evaluate operation in a variety of ways. The evaluation module 142, for instance, may evaluate model performance under two settings: without perturbation types and with perturbation types. In the first setting, the evaluation module 142 may use standard, unaltered original evaluation data to assess model performance. In the second setting, the evaluation module 142 may introduce different perturbations to the evaluation data. By comparing model performance under these two settings, the evaluation module 142 may assess the resilience of the machine-learning model 134 trained using the training data 218 to schema evolution in query translation.

The evaluation module 142 may employ various evaluation metrics to comprehensively assess model performance. One such metric includes a table match score, which is a measure of how well the machine-learning model 134 correctly identifies the relevant tables to generate a valid database query. The table match score may be calculated as the harmonic mean of precision and recall, where precision represents a percentage of correctly predicted tables out of an entirety of available tables predicted by the machine-learning model 134. Recall represents a percentage of correctly predicted tables out of the tables that are selectable. A higher table match score, therefore, may indicate better performance in selecting the correct tables for a database query.

Another metric that may be utilized by the evaluation module 142 is a column match score. The column match score is usable to evaluate how accurately the machine-learning model 134 identifies relevant columns usable to generate a valid database query from a natural language query. Similar to the table match score, the column match score is a measure of balance between precision and recall but applied specifically to the columns of the database. A higher column match score, in this example, may indicate better performance in selecting correct columns for use in a database query.

The variation type evaluation module 502 then generates a type evaluation result 504 which is then usable to a training query selection module 506 as further described in relation to FIG. 8 to select a set of the plurality of database query variations 210 for inclusion in the training data 218. By employing these metrics, the variation type evaluation module 502 may provide a comprehensive evaluation of model performance in both standard and perturbed environments, allowing for detailed analysis of robustness and adaptability across different models and schema evolution types.

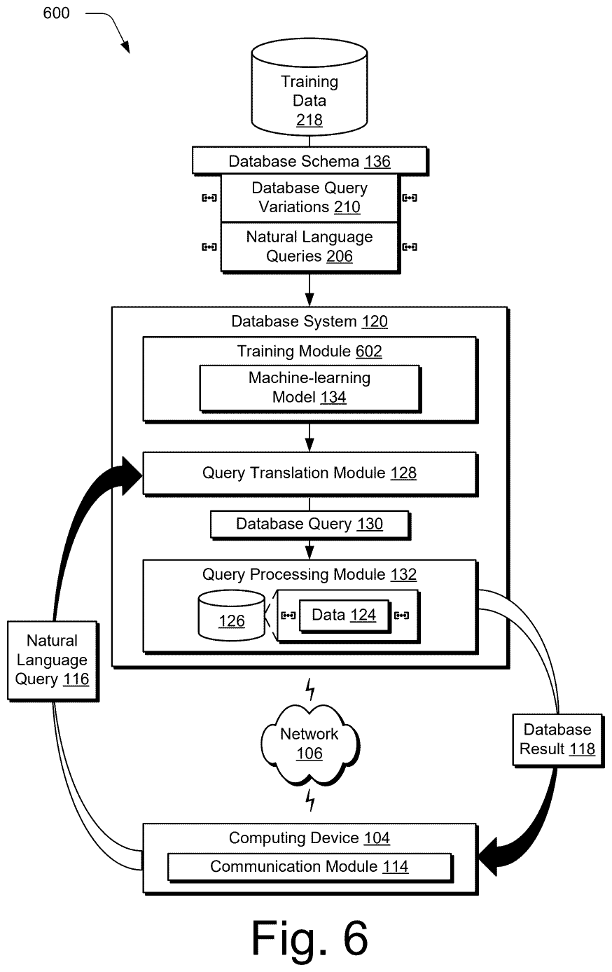

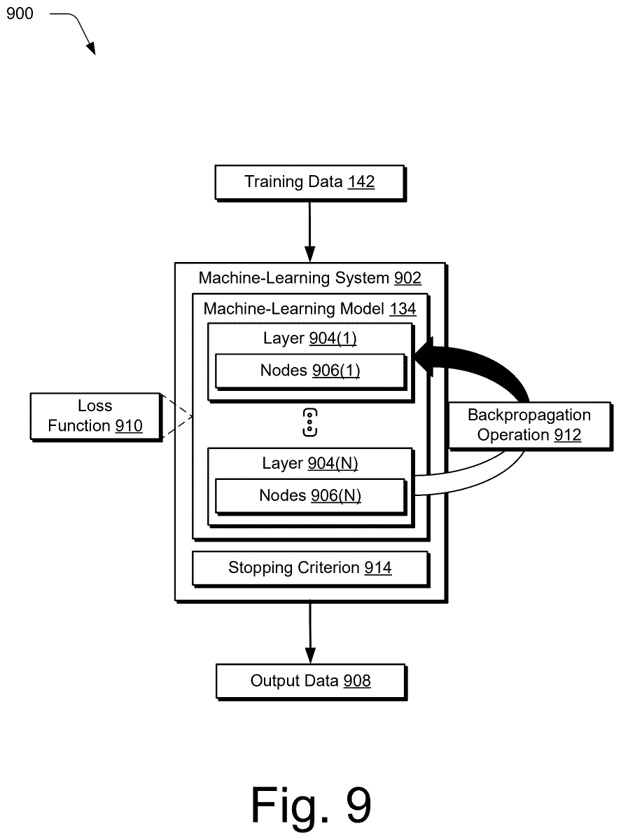

FIG. 6 depicts a system 600 showing operation of the database system 120 in greater detail as training the machine-learning model 134 based on the training data 218. A training module 602, for instance, obtains the database schema 136, the database query variations 210, and the natural language queries 206. The training data 218 is also configurable to include, in one or more examples, the database queries 204 an edited database schema used to generate the plurality of database query variations 210, and so forth. Further discussion of training of the machine-learning model 134 is described in relation to FIG. 9.

Once trained, the query conversion module 128 employs the machine-learning model 134 to process the natural language query 116 to form a database query 130 that is compatible with the database manager module 122 to generate the result 118. The query processing module 132, for instance, processes the database query 130 to form the database result 118 based on data 124 included in the database 126. A variety of other examples are also contemplated.

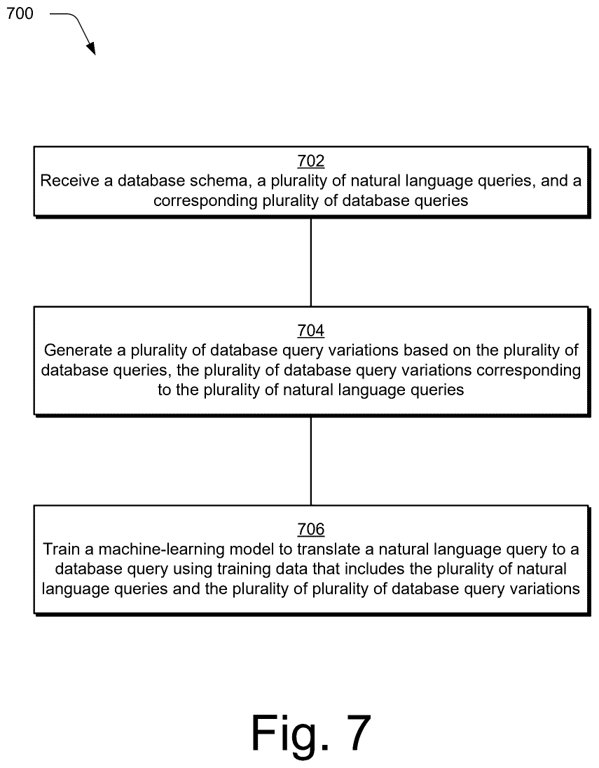

FIG. 7 is a flow diagram depicting an algorithm 700 as a step-by-step procedure in an example implementation of operations performable for accomplishing a result of training data generation and training a machine-learning model for natural language to database query translation. The following discussion describes techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

To begin in this example, a database schema, a plurality of natural language queries, and a corresponding plurality of database queries are received (block 702). The training data generation module 140, for instance, receives this input data as a basis to implement a schema evolution synthesis framework. The database schema 136 may define the structure and organization of the database, including tables, columns, and relationships. The natural language queries 206 may represent user-generated questions or commands in everyday language, while the corresponding database queries 204 may include formal, structured representations of these queries that are executable by the database 126.

Next, a plurality of database query variations 210 are generated based on the plurality of database queries 204. The plurality of database query variations correspond to the plurality of natural language queries (block 704), respectively. The training data generation module 140, as described in relation to FIG. 3, may employ various perturbation techniques to create multiple variations of the original database queries. These variations may simulate different types of schema evolution scenarios, such as adding, removing, or renaming columns and tables. The generated variations maintain correspondence to the original natural language queries 206, ensuring that the semantic intent of the queries is preserved across different schema configurations.

A machine-learning model 134 is then trained to translate a natural language query to a database query using training data 218 that includes the plurality of natural language queries 206 and the plurality of plurality of database query variations 210 (block 706). The training module 602, for instance, utilizes the collected natural language queries and the generated database query variations as training data for the machine-learning model 134. In this way, the machine-learning model 134 is trained to understand relationships between natural language inputs and their corresponding database query representations across various schema configurations. By exposing the machine-learning model 134 to a wide range of query variations, the machine-learning model 134 may learn to adapt to different schema evolution scenarios, thereby improving an ability of the machine-learning model 134 to accurately translate natural language queries into valid database queries even when faced with unfamiliar or modified database schemas.

FIG. 8 is a flow diagram depicting an algorithm 800 as a step-by-step procedure in an example implementation of operations performable for accomplishing a result of training data generation and training a machine-learning model for natural language to database query translation. The following discussion describes techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

To begin in this example, a plurality of database query variations are generated based on a plurality of database queries corresponding to a plurality of natural language queries (block 802). In this step, the training data variation module 208 generates multiple variations of the original database queries, simulating different schema evolution scenarios. These variations may include modifications such as adding or removing columns, renaming tables, or splitting and merging tables. The generated database query variations 210 maintain their correspondence to the original natural language queries, ensuring that the semantic intent of the queries is preserved across different schema configurations.

Next, an evaluation module 142 is employed to evaluate one or more variation types from the plurality of database query variations 210 (block 804). The evaluation module 142, for instance, may assess the different types of variations. This evaluation may involve analyzing the impact of each variation type on query structure, complexity, and execution. The evaluation module 142 may consider factors such as the frequency of occurrence of each variation type in real-world scenarios, the potential impact on query performance, and the challenges present for natural language to database translation.

The evaluation module 142 then selects a set of the plurality of database query variations 210 based on the evaluation (block 806). The evaluation module 142, for instance, may choose a subset of the generated database query variations 210 for inclusion in the training data. This selection process may prioritize variations that have a higher likelihood of enhancing an ability of the machine-learning model 134 to handle diverse schema evolution scenarios. The selection criteria may include factors such as the variation's representativeness of real-world schema changes, potential to challenge the capabilities of machine-learning model 134, contribution to the overall diversity of the training data 218, and so forth.

A machine-learning model 134 is then trained by a training module 602 to translate a natural language query to a database query. The training uses training data 218 that includes the set of plurality of plurality of database query variations and corresponding ones of the plurality of natural language queries (block 808). The training module 602, for instance, utilizes the selected set of database query variations along with their corresponding natural language queries as training data for the machine-learning model 134. The machine-learning model 134 is then trained to understand the relationships between natural language inputs and corresponding database query representations various schema configurations. By exposing the machine-learning model 134 to a carefully curated set of database query variations, the machine-learning model 134 learns to adapt to different schema evolution scenarios, thereby improving an ability to accurately translate natural language queries into valid database queries even when faced with unfamiliar or modified database schemas.

FIG. 9 depicts a system 900 in an example implementation showing training of the machine-learning model 134 of FIG. 1. The machine-learning model 134 is illustrated as implemented as part of a machine-learning system 902. The machine-learning system 902 is representative of functionality to train the machine-learning model 134, and/or use the trained machine-learning model 134 as implementing the functionality described herein.

A machine-learning model 134 refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In the illustrated example, the machine-learning model 134 is configured using a plurality of layers 904(1), . . . , 904(N) having, respectively, a plurality of nodes 906(1), . . . , 906(N). The plurality of layers 904(1)-904(N) are configurable to include an input layer, an output layer, and one or more hidden layers. Calculations are performed by the nodes 906(1)-906(N) within the layers via hidden states through a system of weighted connections that are “learned” during training of the machine-learning model 134 to implement a variety of tasks.

In order to train the machine-learning model 134, evaluation module 142 is received that provides examples of “what is to be learned” by the machine-learning model 134, i.e., as a basis to learn patterns from the data. The machine-learning system 902, for instance, collects and preprocesses the evaluation module 142 that includes input features and corresponding target labels, i.e., of what is exhibited by the input features), such as the natural language query and the database query.

The machine-learning system 902 then initializes parameters of the machine-learning model 134, which are used by the machine-learning model 134 as internal variables to represent and process information during training and represent interferences gained through training. In an implementation, the evaluation module 142 is separated into batches to improve processing and optimization efficiency of the parameters of the machine-learning model 134 during training.

The evaluation module 142 is then received as an input by the machine-learning model 134 and used as a basis for generating predictions based on a current state of parameters of layers 904(1)-904(N) and corresponding nodes 906(1)-906(N) of the model, a result of which is output as output data 908. Output data 908 describes an outcome of the task, e.g., as a probability of being a member of a particular class in a classification scenario.

Training of the machine-learning model 134 includes calculating a loss function 910 to quantify a loss associated with operations performed by nodes of the machine-learning model 134. The calculating of the loss function 910, for instance, includes comparing a difference between predictions specified in the output data 908 with target labels specified by the evaluation module 142. The loss function 910 is configurable in a variety of ways, examples of which include regret, Quadratic loss function as part of a least squares technique, and so forth.

Calculation of the loss function 910 also includes use a backpropagation operation 912 as part of minimizing the loss function 910 and thereby training parameters of the machine-learning model 134. Minimizing the loss function 910, for instance, includes adjusting weights of the nodes 906(1)-906(N) in order to minimize the loss and thereby optimize performance of the machine-learning model 134 in performance of a particular task, e.g., query translation. The adjustment is determined by computing a gradient of the loss function 910, which indicates a direction to be used in order to adjust the parameters to minimize the loss. The parameters of the machine-learning model 134 are then updated based on the computed gradient.

This process continues over a plurality of iteration in an example until a stopping criterion 914 is met. The stopping criterion 914 is employed by the machine-learning system 902 in this example to reduce overfitting of the machine-learning model 134, reduce computational resource consumption, and promote an ability of the machine-learning model 134 to address previously unseen data, i.e., that is not included specifically as an example in the evaluation module 142. Examples of a stopping criterion 914 include but are not limited to a predefined number of epochs, validation loss stabilization, achievement of a performance improvement threshold, or based on performance metrics such as precision and recall.

### Example System and Device

FIG. 10 illustrates an example system generally at 1000 that includes an example computing device 1002 that is representative of one or more computing systems and/or devices that implement the various techniques described herein. This is illustrated through inclusion of schema synthesis system 138. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The computer-readable storage medium is configured for storing instructions that, responsive to execution by the processing device, causes the processing device to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

In implementations, the platform 1016 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a processing device, a database schema, a plurality of natural language queries, and a corresponding plurality of database queries;
generating, by the processing device, a plurality of database query variations based on the plurality of database queries, the plurality of database query variations corresponding to the plurality of natural language queries and a modification of the database schema;
training, by the processing device, a machine-learning model to translate a natural language query to a database query using training data that includes the plurality of natural language queries and the plurality of plurality of database query variations;
evaluating, by the processing device, training of the machine-learning model on the training data using one or more metrics as measuring performance of the machine-learning model in translating the natural language query to a database query based, at least in part, on the modification of the database schema; and
selecting, by the processing device, additional training data based, at least in part, on results of evaluating the machine-learning model on the modification of the database schema.

2. The method as described in claim 1, wherein the generating the plurality of database query variations including editing the database schema and the plurality of database query variations are generated based on the edited database schema.

3. The method as described in claim 2, wherein the training data further includes the database schema or the edited database schema.

4. The method as described in claim 1, wherein the generating is performed using a language model as part of machine learning using a prompt indicating a respective variation.

5. The method as described in claim 1, wherein the plurality of database query variations include one or more column-level variations.

6. The method as described in claim 5, wherein the one or more column-level variations include an add column variation, a remove column variation, and a rename column variation.

7. The method as described in claim 1, wherein the plurality of database query variations include one or more table-level variations.

8. The method as described in claim 7, wherein the one or more table-level variations include an add table variation, a remove table variation, a rename table variation, a split table variation, and a merge table variation.

9. The method as described in claim 1, further comprising evaluating the plurality of database query variations based on variation type and selecting a set of the plurality of database query variations for inclusion in the training data based on the evaluating.

10. The method as described in claim 1, wherein the database query is a structured query language (SQL) query.

11. A computing device comprising:
a processing device; and
a computer-readable storage medium storing instructions that, responsive to execution by the processing device, causes the processing device to perform operations including:
generating a plurality of database query variations based on a plurality of database queries corresponding to a plurality of natural language queries and a database schema;
evaluating one or more variation types from the plurality of database query variations;
selecting a set of the plurality of database query variations based on the evaluating and a modification of the database schema;
training a machine-learning model to translate a natural language query to a database query, the training using training data that includes the set of plurality of plurality of database query variations and corresponding ones of the plurality of natural language queries;
evaluating training of the machine-learning model on the training data using one or more metrics as measuring performance of the machine-learning model in translating the natural language query to a database query based, at least in part, on the modification of the database schema; and
selecting additional training data based, at least in part, on results of evaluating the machine-learning model on the modification of the database schema.

12. The computing device as described in claim 11, wherein the generating the plurality of database query variations including editing a database schema and the plurality of database query variations are based on the edited database schema.

13. The computing device as described in claim 11, wherein the generating is performed using a language model as part of machine learning using a prompt indicating a respective variation.

14. The computing device as described in claim 11, wherein the plurality of database query variations include one or more column-level variations, the one or more column-level variations including an add column variation, a remove column variation, or a rename column variation.

15. The computing device as described in claim 11, wherein the plurality of database query variations include one or more table-level variations, the one or more table-level variations including an add table variation, a remove table variation, a rename table variation, a split table variation, or a merge table variation.

16. One or more computer-readable storage media having instructions stored thereon that, responsive to execution by a processing device, causes the processing device to perform operations comprising:
training a machine-learning model to translate a natural language query to a database query using training data that includes a plurality of natural language queries and a plurality of database query variations, the plurality of database query variations generated based on at least one edit made to a corresponding database schema;
receiving a natural language query;
forming a database query by translating the natural language query using the trained machine-learning model;
generating a database result by querying a database using the database query;
evaluating training of the machine-learning model on the database result using one or more metrics as measuring performance of the machine-learning model in translating the natural language query to a database query based, at least in part, on the at least one edit made to the corresponding database schema; and
selecting additional training data based, at least in part, on results of evaluating the machine-learning model on the at least one edit made to the corresponding database schema.

17. The one or more computer-readable storage media as described in claim 16, wherein the plurality of database query variations include one or more column-level variations, the one or more column-level variations including an add column variation, a remove column variation, or a rename column variation.

18. The one or more computer-readable storage media as described in claim 16, wherein the plurality of database query variations include one or more table-level variations, the one or more table-level variations including an add table variation, a remove table variation, a rename table variation, a split table variation, or a merge table variation.

19. The one or more computer-readable storage media as described in claim 16, wherein the database query is a structured query language (SQL) query.

20. The one or more computer-readable storage media as described in claim 16, wherein the plurality of database query variations are generated using a language model as part of machine learning based on a prompt indicating a respective variation.
